(19) United States
(12) Patent Application Publication
(10) Pub. No.: US 2022/0001345 A1
(43) Pub. Date: Jan. 6, 2022

(54) FATTY AMINE TYPE EMULSIFIERS AND THEIR USE IN ASPHALT EMULSIONS AND APPLICATIONS

(71) Applicant: CARGILL, INCORPORATED, Wayzata, MN (US)

(72) Inventors: Sung AHN, St. Paul, MN (US); Todd L. KURTH, Maple Grove, MN (US); Hassan Ali TABATABAEE, Plymouth, MN (US)

(73) Assignee: CARGILL, INCORPORATED, Wayzata, MN (US)

(21) Appl. No.: 17/283,346

(22) PCT Filed: Oct. 11, 2019
(86) PCT No.: PCT/US2019/055844

§ 371 Date: Apr. 7, 2021

Related U.S. Application Data
(60) Provisional application No. 62/744,432, filed on Oct. 11, 2018.

(51) Int. Cl. B01F 17/00; C08L 95/00

(52) U.S. Cl. CPC B01F 17/0042; C08L 2555/60; B01F 17/0021; C08L 95/005

(57) ABSTRACT

Various embodiments disclosed relate to asphalt emulsifiers. An emulsifier has the structure R¹—C(O)-A-(CH₂)ₙ—N(R²) (R³), or a salt thereof wherein the —N(R²)(R³) nitrogen is quaternized as —N⁺(R²)(R³)(R⁴), or an N-oxide thereof wherein the —N(R²) (R³) nitrogen is oxidized as —N⁺(R²)(R³)(O⁻). The variable A is —NH— or —O—. The variable R¹ is chosen from (C₄-C₂₂)alkyl, substituted (C₄-C₂₂)alkyl, (C₄-C₂₂)alkenyl, and substituted (C₄-C₂₂)alkenyl. The variables R² and R³ are each independently chosen from (C₁-C₁₀)alkyl and substituted (C₁-C₁₀)alkyl. The variable R⁴ is chosen from —H, (C₁-C₂₀)hydrocarbyl, and substituted (C₁-C₂₀)hydrocarbyl. The variable n is 1 to 10. Various embodiments include methods of making the emulsifier such as from a fatty acid source and an amine starting material, emulsions including the emulsifier and methods of making the same, and methods of using the emulsion including contacting asphalt or bitumen with the emulsion.

### CROSS-REFERENCE TO RELATED APPLICATIONS

This application claims the benefit of U.S. Provisional Patent Application No. 62/744,432, filed Oct. 11, 2018, entitled ASPHALT EMULSIFIERS, which is hereby incorporated by reference in its entirety.

### BACKGROUND

Asphalt-in-water emulsions are used for road construction and repair, in the construction industry as coatings and sealers, as well as for other industrial coating applications such as automotive or piping. The asphalt properties are obtained after the emulsions set or cure, when the droplets of asphalt coalesce and adhere to the substrate and water is removed.

Asphalt ages through a combination of mechanisms, mainly oxidation and volatilization. Aging increases asphalt modulus, decreases viscous dissipation and stress relaxation, and increases brittleness at lower performance temperatures. As a result, the asphalt becomes more susceptible to cracking and damage accumulation. Aging of asphalt has also been shown to increase colloidal instability and phase incompatibility, such as by increasing the content of high molecular weight and highly polar insoluble asphaltene fraction which may increasingly associate. Asphalt-in-water emulsions or oil-in-water emulsions can be used to partially or completely restore the rheological and fracture properties of the aged asphalt, and can be used to recycle and reclaim bituminous materials which contain aged asphalt binder from sources such as reclaimed asphalt pavements (RAP) and recycled asphalt shingles (RAS). Oil-in-water emulsions can also be used to adjust or improve the properties of unaged asphalts.

Asphalt-in-water emulsions and oil-in-water emulsions for asphalt treatment require an emulsifier to form the emulsion and that allows the emulsion to set or cure under the desired conditions. Suitable emulsifiers can be an expensive component of such emulsions, can be inconvenient to obtain, and can suffer from environmentally unsustainable sourcing.

### SUMMARY OF THE INVENTION

In various embodiments, the present invention provides an emulsifier having the structure:

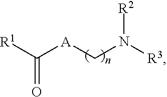

or a salt thereof wherein the —N(R²)(R³) nitrogen is quaternized as —N⁺(R²)(R³)(R⁴), or an N-oxide thereof wherein the —N(R²)(R³) nitrogen is oxidized as —N⁺(R²)(R³)(O⁻). The variable A is —NH— or —O—. The variable R¹ is chosen from (C₄-C₂₂)alkyl, substituted (C₄-C₂₂)alkyl, (C₄-C₂₂)alkenyl, and substituted (C₄-C₂₂)alkenyl. The variables R² and R³ are each independently chosen from (C₁-C₁₀)alkyl and substituted (C₁-C₁₀)alkyl. The variable R⁴ is chosen from —H, (C₁-C₂₀)hydrocarbyl, and substituted (C₁-C₂₀)hydrocarbyl. The variable n is 1 to 10.

In various embodiments, the present invention provides an emulsifier composition including the emulsifier and further including a monoacylglyceride or diacylglyceride compound:

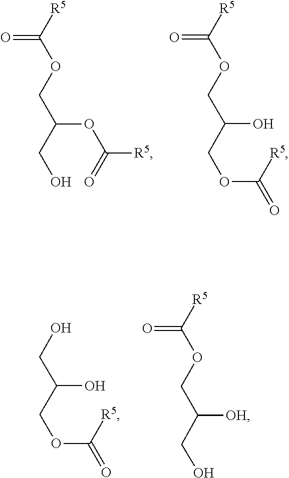

or a combination thereof. The variable R⁵ is substituted or unsubstituted (C₄-C₂₂)alkyl or substituted or unsubstituted (C₄-C₂₂)alkenyl.

In various embodiments, the present invention provides a polymerized emulsifier including a polymerized product of the emulsifier having the structure R¹—C(O)-A-(CH₂)ₙ—N(R²)(R³), a salt thereof wherein the —N(R²)(R³) nitrogen is quaternized as —N⁺(R²)(R³)(R⁴), or wherein the —N(R²)(R³) nitrogen is oxidized as —N⁺(R²)(R³)(O⁻). In various embodiments, the present invention provides a polymerized emulsifier composition including a polymerized product of the emulsifier composition that includes monoacylglycerides or diacylglycerides.

In various embodiments, the present invention provides a method of making the emulsifier, or the emulsifier composition. The method includes contacting a fatty acid source including R¹ and an amine starting material to form the emulsifier or emulsifier composition.

In various embodiments, the present invention provides an emulsion including the emulsifier or the emulsifier composition, the emulsion including water and a hydrophobic phase.

In various embodiments, the present invention provides an emulsion. The emulsion includes asphalt, oil, or a combination thereof. The emulsion includes water. The emulsion also includes the emulsifier, the emulsifier composition, the polymerized emulsifier, or a combination thereof.

In various embodiments, the present invention provides a curable composition, a hydrophobization composition, an antistripping additive, a warm mix composition, a compaction aid, or a combination thereof, including the emulsifier, the emulsifier composition, or the polymerized emulsifier.

In various embodiments, the present invention provides a method of forming the emulsion. The method includes combining asphalt or oil, water, and the emulsifier, to form the emulsion.

In various embodiments, the present invention provides a method of using the emulsion. The method includes contacting the emulsion and asphalt or bituminous material.

In various embodiments, the present invention provides a method of using the emulsion to perform a chip seal. The method includes contacting the emulsion, a chip seal aggregate, and a pavement surface comprising asphalt or bituminous material, to perform a chip seal.

In various embodiments, the emulsifiers of the present invention, emulsions formed therewith, and methods of forming and using the same can have certain advantages over other emulsifiers or emulsions, at least some of which are unexpected. For example, in various embodiments, the fatty acid source used to form the emulsifier can be a flexible source, such as a bio-based fatty acid source or a petroleum-based source. In various embodiments, the amine source used to form the emulsifier can be a flexible source. In various embodiments, the emulsifier of the present invention can be derived from bio-based renewable starting materials and can provide similar or better emulsification properties for asphalt-in-water or oil-in-water emulsions than emulsifiers that are petroleum or non-renewably derived.

In various embodiments, the emulsifier of the present invention can more effectively and easily provide an asphalt-in-water or oil-in-water emulsion, as compared to other emulsifiers. In some embodiments, asphalt-in-water or oil-in-water emulsions formed using the emulsifier of the present invention can be more effective rejuvenators of aged asphalt, providing better resultant properties at lower cost, with higher speed, with greater convenience, or a combination thereof, than possible with other emulsifiers. In various embodiments, the emulsifier of the present invention can be used to form asphalt-in-water or oil-in-water emulsions using a lower concentration of asphalt or oil but having similar or better overall properties for treating asphalt or bituminous materials, as compared to emulsions formed from other emulsifiers. In various embodiments, the emulsifier of the present invention can be used to form asphalt-in-water or oil-in-water emulsions having a particular viscosity using a lower concentration of asphalt or oil than needed to achieve the same viscosity using other emulsifiers.

In various embodiments, the emulsifier of the present invention can be used to form an emulsion having smaller droplet size as compared to emulsions formed with other emulsifiers. In various embodiments, the emulsifier of the present invention can provide an emulsion that can set at a higher speed, and that can have a faster viscosity build when setting, as compared to other emulsifiers. In various embodiments, the emulsifier of the present invention can provide an emulsion with better storage stability, such as neat at room temperature, with less settling or breakage of the emulsion, than emulsions formed from other emulsifiers.

In various embodiments, the emulsifier of the present invention provides unique performance and desirable qualities when used in cationic rapid setting applications or high float emulsions for applications such as chip seals and fog seals (with or without asphalt or rejuvenator in the residue), or in cationic medium setting emulsions, such as those used for rejuvenating scrub seals. In various embodiments, emulsions formed using the emulsifier of the present invention provide the building of a suitable and stable viscosity without using excessively high residue content, making formulations potentially more economical, while also demonstrating superior emulsion storage stability, both in terms of stability against premature breaking and in terms of retaining desirable viscosities. In various embodiments, when used in rapid setting applications, emulsions made with the emulsifier of the present invention can have ideal break and set times, and good chip retention strength. These properties can result in the ability to open chip-sealed pavements to traffic without excessive delay, and can mitigate loss of chips and aggregate on the surface under traffic. In various embodiments, these properties can exist in emulsions including the emulsifier of this invention that include polymer-modified residues, rejuvenator-modified residues, and neat residues.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others. An alkenyl group can include any suitable number of unsaturated groups (i.e., of C═C bonds), such as 1, 2, 3, 4, or 5 or more.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups. The term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

As used herein, the term “polymer” refers to a molecule having at least one repeating unit and can include copolymers.

### Emulsifier.

The present invention provides an emulsifier having the structure:

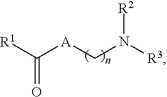

or a salt thereof wherein the —N(R²)(R³) nitrogen is quaternized as —N⁺(R²)(R³)(R⁴), or an N-oxide thereof wherein the —N(R²)(R³) nitrogen is oxidized as —N⁺(R²)(R³)(O⁻). The variable A can be —NH— or —O—. The variable R¹ can be chosen from (C₄-C₂₂)alkyl, substituted (C₄-C₂₂)alkyl, (C₄-C₂₂)alkenyl, and substituted (C₄-C₂₂)alkenyl. The variables R² and R³ can be each independently chosen from (C₁-C₁₀)alkyl and substituted (C₁-C₁₀)alkyl. The variable R⁴ can be chosen from —H, (C₁-C₂₀)hydrocarbyl, and substituted (C₁-C₂₀)hydrocarbyl. The variable n can be 1 to 10.

In some embodiments the emulsifier is neutral in charge and does not include a counterion. In other embodiments, the emulsifier is a salt. In some embodiments, the terminal nitrogen can have a positive charge due to further substituted with a proton or with an R² group and the emulsifier can include a suitable counterion. The emulsifier can be a salt of an acid and can have the structure:

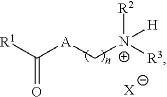

The variable X⁻ can be any suitable counterion. The acid can be an organic acid or mineral acid, and the variable X− can be any suitable conjugate base. The acid can be a carboxylic acid and X⁻ can be a carboxylate group. The acid can be H₃PO₄, and X⁻ can be H₂PO₄⁻. The acid can be a hydrohalic acid, and the variable X⁻ can be a halide ion, such as I⁻, Br⁻, or Cl⁻. The emulsifier can be a hydrochloride salt. In other embodiments, the —N(R²)(R³) nitrogen is quaternized as —N⁺(R²)(R³)(R⁴) and the emulsifier includes a counterion such as X⁻ or another suitable counterion. In other embodiments R⁴ is not H, and is instead a hydrocarbyl group formed by a nucleophilic attack of the terminal nitrogen on the structure R⁴—X, such as an hydrocarbyl halide.

The R¹ group of the emulsifier can be derived from any suitable fatty acid source, such as one or more fatty acids or triglycerides. The variable R¹ can be derived from a petrochemical fatty acid source, R¹ can be derived from a bio-based fatty acid source, or a combination thereof. The bio-based fatty acid source can be free fatty acids, a plant-based oil (e.g., soybean oil), animal-based oil (e.g., lard, tallow), deodorizer distillate, recovered corn oil (e.g., residual liquids resulting from the manufacturing process of turning corn into ethanol, also known as “corn stillage oil”) or derivatives thereof (e.g., polymerized corn oil streams), refined bleached deodorized soy bean oil (RBD SBO), an ultrafiltered oil, a technical grade oil, a waste vegetable-based or plant-based oil (e.g., waste cooking oil), a distillate (e.g., a waste-derived distillate or a waste steam distillate), or a combination thereof. Deodorizer distillate is a product from physical or enzymatic refining of vegetable oils, and it is generally fatty acid but also contains ester and many minor impurities found in the various vegetable streams. Examples of plant-based oils can include soybean oil, linseed oil, canola oil, rapeseed oil, castor oil, tall oil, cottonseed oil, sunflower oil, palm oil, peanut oil, safflower oil, corn oil, corn stillage oil, lecithin (phospholipids) and combinations and crude streams thereof. In some embodiments, the bio-based fatty acid source is soy oil, canola oil, sunflower oil, or a combination thereof.

The fatty acid source from which R¹ is derived can be modified or unmodified. Modification can include functionalization with one or more heteroatoms (e.g., substitution on R¹ with O, N, S, P, or a combination thereof, alone or as part of another functional group). Modification can include hydrogenation, fractionation, branching, epoxidation, vulcanization, polymerization (e.g., dimerized product, a trimerized product, or an oligomerized product of the fatty acid source), maleic anhydride modification, acrylic acid modification, dicyclopentadiene modification, conjugation via reaction with iodine, interesterification, processing to modify acid value, processing to modify hydroxyl number, or a combination thereof.

The variable R¹ is substituted or unsubstituted (C₄-C₂₂)alkyl or substituted or unsubstituted (C₄-C₂₂)alkenyl. The variable R¹ can be unsubstituted. The alkenyl group can have any suitable number of carbon-carbon double bonds, such as 1, 2, 3, 4, 5, or more. The variable R¹ can be (C₁₀-C₂₀)alkyl or (C₁₀-C₂₀)alkenyl. The variable R¹ can be (C₁₆-C₁₈)alkyl or (C₁₆-C₁₈)alkenyl. The variable R¹ can be (C₁₆-C₁₈)alkyl or (C₁₈)alkenyl.

Waste oil streams can be efficient and useful fatty acid sources. For example, distillate streams, vegetable oils, and recovered corn oil streams, can be cost-effective fatty acids sources as well as fatty acids derived from waste streams containing phosphatides and other impurities (e.g., sterols, tocopherols, starches, waxes, etc.). However, fatty acids in their natural or synthetic form may also be utilized herein as the fatty acid source. The fatty acid source may also derived from a combination of various waste streams, a combination of various natural or synthetic oils, or a combination of both waste streams and natural/synthetic oil.

The variables R² and R³ can be independently chosen from substituted or unsubstituted (C₁-C₁₀)alkyl. The variables R² and R³ can be unsubstituted. At each occurrence, R² and R³ can be independently chosen from (C₁-C₆)alkyl. The variables R² and R³ can be independently chosen from (C₁-C₃)alkyl. The variables R² and R³ can be methyl.

The variable R⁴, if present, can be chosen from —H, (C₁-C₂₀)hydrocarbyl, and substituted (C₁-C₂₀)hydrocarbyl. The variable R⁴ can be (C₁-C₂₀)hydrocarbyl, such as ethyl or benzyl. The variable R⁴ can be —H.

The variable n is 1 to 10, or 1 to 6, or 2 to 4, or 3. The variable n can be 1, or less than, equal to, or greater than 2, 3, 4, 5, 6, 7, 8, 9, or 10.

The emulsifier can be an amidopropylamine. The emulsifier can have the structure:

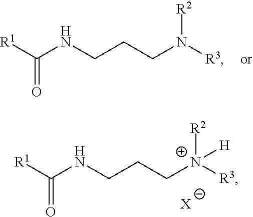

In some embodiments, X⁻ is a halide ion, and R² and R³ are (C₁-C₃)alkyl such as methyl.

In some embodiments, the emulsifier can be formed by amidation of a combination of coconut fatty acid and a distillate from soybean processing and coconut fatty acid with dimethylaminopropylamine. The emulsifier can be formed by amidation of acidulated and distilled sunflower soap stock (i.e., a waste-derived fatty acid) with dimethylaminopropylamine. The emulsifier can be formed by amidation of refined bleached and deodorized soybean oil with dimethylaminopropylamine. The the emulsifier can be formed by amidation of recovered corn oil (i.e., corn stover oil) and dimethylaminopropylamine. The emulsifier can be formed by amidation of coconut oil and dimethylaminopropylamine.

The emulsifier can have any suitable acid value (i.e., the mass of potassium hydroxide needed in mg to neutralize one gram of emulsifier). The emulsifier has an acid value of about 0 to about 20 mg KOH/g, or about 0 to about 10 mg KOH/g, or about 0, or less than, equal to, or greater than about 2, 4, 6, 8, 10, 12, 14, 16, 18, or about 20 mg KOH/g or more. The emulsifier can have any suitable amine value (i.e., the mass of potassium hydroxide in mg equivalent to basicity in one gram). The non-quaternary non-oxide form of the emulsifier can have an amine value of about 100 to about 200 mg KOH/g, or about 140 to about 160 mg KOH/g, or about 100 or less, or less than, equal to, or greater than about 110, 120, 130, 140, 145, 150, 155, 160, 170, 180, 190, or about 200 mg KOH/g or more. In various embodiments, the quaternary or amine-oxide form of the emulsifier can have an amine value of near 0 KOH/g using the measurement techniques described herein.

Various embodiments of the present invention provide a modified emulsifier that is a modified product of an embodiment of the emulsifier described herein. For example, the modified product can be a polymerized product (e.g., dimerized product, a trimerized product, or an oligomerized product of the emulsifier), or can be modified via hydrogenation, fractionation, branching, epoxidation, vulcanization, maleic anhydride modification, acrylic acid modification, dicyclopentadiene modification, conjugation via reaction with iodine, interesterification, processing to modify acid value, processing to modify hydroxyl number, or a combination thereof.

### Emulsifier Composition.

Various embodiments of the present invention provide an emulsifier composition. The emulsifier composition can be any suitable composition that includes an embodiment of the emulsifier described herein. In addition to the emulsifier, various other components can be present. For example, in embodiments of the emulsifier formed from triglycerides, products of partially reacted triglycerides can be components of the emulsifier composition. For example, the emulsifier composition can include monoacylglyceride or diacylglyceride compound:

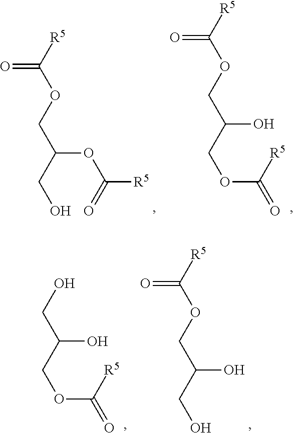

or a combination thereof. The variable R⁵ can be a substituted or unsubstituted (C₄-C₂₂)alkyl or substituted or unsubstituted (C₄-C₂₂)alkenyl. The variable R⁵ can be the same as R¹. The variable R⁵ can be unsubstituted. The alkenyl group can have any suitable number of carbon-carbon double bonds, such as 1, 2, 3, 4, 5, or more. The variable R⁵ can be (C₁₀-C₂₀)alkyl or (C₁₀-C₂₀)alkenyl. The variable R⁵ can be (C₁₆-C₁₈)alkyl or (C₁₆-C₁₈)alkenyl. The variable R⁵ can be (C₁₆-C₁₈)alkyl or (C₁₈)alkenyl.

The emulsifier composition can in some embodiments include other components from the fatty acid source or from other sources, as an alternative to or in addition to monoacylglyceride or diacylglyceride compounds, such fatty acid soaps, or such as components resulting from the refining or distillation of the fatty acids, or other components. In some embodiments, the monoacylglyceride compounds, diacylglyceride compounds, other components, or a combination thereof, can have surfactant properties that can contribute to the overall performance of the emulsion composition.

Various embodiments of the present invention provide a modified emulsifier composition that is a modified product of an embodiment of the emulsifier composition described herein. For example, the modified product can be a polymerized product (e.g., dimerized product, a trimerized product, or an oligomerized product of the emulsifier composition), or can be modified via hydrogenation, fractionation, branching, epoxidation, vulcanization, maleic anhydride modification, acrylic acid modification, dicyclopentadiene modification, conjugation via reaction with iodine, interesterification, processing to modify acid value, processing to modify hydroxyl number, or a combination thereof.

### Method of Making the Emulsifier.

Various embodiments provide a method of making the emulsifier. The method can be any suitable method that forms an embodiment of the emulsifier or emulsifier composition described herein. The method can include contacting a fatty acid source including R¹ and an amine starting material to form the emulsifier or emulsifier composition. The method can include removing water or other byproducts from the reaction to drive the reaction toward the emulsifier. The method can include using a catalyst, such as sodium methoxide, a base (e.g., NaOH, KOH), or a combination thereof, such as for reaction of oil fatty acid sources with the amine starting material. The relative amounts of the fatty acids and the amine can be added in an approximately stoichiometric amount. The amines can be added such that about 50% to about 100% of the fatty acids or triglycerides react, or about 80-95%, or less than, equal to, or greater than about 60%, 70, 80, 82, 84, 86, 88, 90, 92, 94, 96, 98, or about 99% or more react.

The fatty acid source and the amine starting material can be contacted under any suitable conditions such that the emulsifier is formed. The fatty acid source and the amine starting material can be contacted at about 100° C. to about 200° C., or about 130° C. to about 170° C., or about 100° C. or less, or less than, equal to, or greater than about 110° C., 120, 130, 135, 140, 145, 150, 155, 160, 165, 170, 180, 190, or about 200° C. or more.

Some embodiments of the method form an emulsifier that is neutrally charged and that is not a salt. Other embodiments of the method include treating the emulsifier to form a salt of the emulsifier, such as treating the emulsifier with an acid to form an acid salt of the emulsifier. The acid can be a mineral acid such as HCl. The acid can be phosphoric acid.

Some embodiments of the method form an embodiment of the emulsifier including the quaternized nitrogen —N⁺(R²)(R³)(R⁴). Such embodiments can include quaternizing the nitrogen atom after reacting the fatty acid source and the amine starting material. In another embodiment, the amine starting material can include the functional group —N⁺(R²)(R³)(R⁴).

The fatty acid source can be any suitable fatty acid source. The fatty acid source can include one or more fatty acids, one or more triglycerides, or a combination thereof. The fatty acid source can be a petrochemical fatty acid source, a bio-based fatty acid source, a modified fatty acid source, an unmodified fatty acid source, or a combination thereof.

The amine starting material can have the structure:

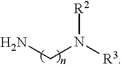

The amine starting material can have the structure:

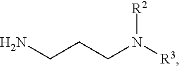

The variables R² and R³ can each be independently chosen from substituted or unsubstituted (C₁-C₁₀)alkyl, (C₁-C₆)alkyl, or (C₁-C₃)alkyl. The variables R² and R³ can be methyl. The variable n is 1 to 10, or 1 to 6, or 2 to 4, or 3. The amine starting material can be dimethylaminopropylamine (DMAPA). In some embodiments, the amine starting material is quaternized at the time of contacting with the fatty acid source.

An embodiment of the method of forming the emulsifier or emulsifier composition, wherein n=3, is shown in Scheme 1. The variable R⁶ can be —H, substituted or unsubstituted alkyl, glycerol, or a glyceride. Although a step of forming the hydrohalide salt is shown, the method need not include the salting step and the salting step can either be performed after completion of the method or the emulsifier can be a neutral compound that is not a salt.

During formation of the emulsifier, any one or more emulsion additives can be used to facilitate the synthesis, such as a defoamer, antifoam agent, or surface tension modifiers.

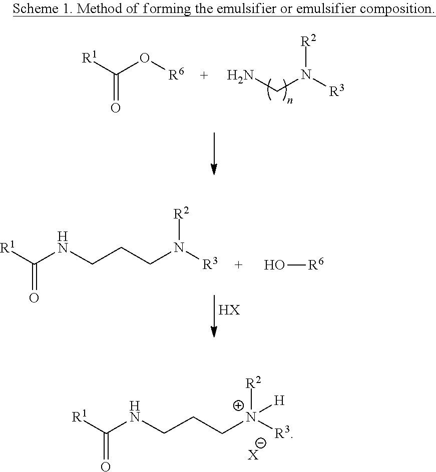

### Emulsion Including the Emulsifier.

In various embodiments, the present invention provides an emulsion including the emulsifier, emulsifier composition, or modified emulsifier described herein. The emulsion can include water and a hydrophobic phase. The hydrophobic phase can be asphalt, oil, or a combination thereof.

The asphalt or oil can form any suitable proportion of the emulsion. The asphalt or oil can be about 10 wt % to about 90 wt % of the emulsion, about 30 wt % to about 80 wt %, about 50 wt % to about 70 wt %, or about 10 wt % or less, or less than, equal to, or greater than about 20 wt %, 30, 35, 40, 45, 50, 55, 60, 65, 70, 75, 80, or about 90 wt % or more.

The water can form any suitable proportion of the emulsion. The water can be about 10 wt % to about 90 wt % of the emulsion, about 20 wt % to about 70 wt %, about 30 wt % to about 50 wt %, or about 10 wt % or less, or less than, equal to, or greater than about 20 wt %, 25, 30, 35, 40, 45, 50, 55, 60, 65, 70, 80, or about 90 wt % or more of the emulsion.

The emulsifier, emulsifier composition, or modified emulsifier, can form any suitable proportion of the emulsion, such as about 0.01 wt % to about 5 wt %, about 0.01 wt % to about 3 wt %, about 0.1 wt % to about 1.5 wt %, about 0.15 wt % to about 0.45 wt %, about 0.3 wt % to about 1.5 wt % of the emulsion, or about 0.01 wt % or less, or less than, equal to, or greater than about 0.05 wt %, 0.1, 0.15, 0.2, 0.25, 0.3, 0.4, 0.5, 0.6, 0.7, 0.8, 0.9, 1, 1.1, 1.2, 1.3, 1.4, 1.5, 1.6, 1.8, 2, 2.2, 2.4, 2.6, 2.8, 3, 3.5, 4.5, or about 5 wt % or more of the emulsion.

The water phase of the emulsion can have any suitable pH. In some embodiments, the water phase of the emulsion has an acidic pH, such that the emulsifier can exist as a salt, such as less than 7, less than 5, or about 1.0 to about 3.0, or about 1.8 to about 2.2, or about 1 or less, or less than, equal to, or greater than about 1.2, 1.4, 1.6, 1.8, 2, 2.2, 2.4, 2.6, 2.8, or about 3 or more.

The emulsion can be an asphalt emulsion, wherein the emulsion includes asphalt and optionally includes oil or is free of oil. As used herein, asphalt, asphalt binder, and bitumen refer to the binder phase of an asphalt pavement. Bituminous material can refer to a blend of asphalt binder and other material such as aggregate or filler. The asphalt can be any suitable asphalt, such as flux, refinery vacuum tower bottoms, pitch or other residues of processing of vacuum tower bottoms, oxidized or aged asphalt from recycled bituminous material (e.g., reclaimed asphalt pavement (RAP), recycled asphalt shingles (RAS)), material acquired from asphalt producing refineries, solvent de-asphalting residues, pitch, brightstock, or residues, side streams, or residues remaining from the production of brightstock (e.g., deasphalted oil (DAO) and de-asphalted cylinder oil (DACO)), or a combination thereof.

The emulsion can be an oil emulsion, wherein the emulsion includes oil and optionally includes asphalt or is free of asphalt. The oil can be any suitable oil, such as a rejuvenating oil, a vegetable oil, a polymerized oil, or a combination thereof.

The emulsion can include any one or more materials in addition to the oil or asphalt, water, and emulsifier. The emulsion can include one or more additives. In various embodiments, the one or more additives can include a rejuvenator, a rejuvenating oil, a rheology modifier, a compatibilizer, a diluent, a cutback, a fuel oil, a pigment, a thermoplastic polymer or an elastomeric polymer (e.g., styrene-butadiene-styrene, ethylene vinyl-acetate, functionalized polyolefins, and the like), tire rubber, a natural or synthetic latex, polyphosphoric acid, lecithin, a gum, a fatty acid, an anti-stripping additive (e.g., amine-based or phosphate-based), a warm mix additive, a co-surfactant or co-emulsifier, a viscosity modifier (e.g., scleroglucan, lignin, or lignin-based additives), a fiber, an emulsion stabilizer, an antioxidant, a defoamer, an antifoamer, a surface tension modifier, or a combination thereof. The one or more additives can form any suitable proportion of the emulsion, such as about 0.01 wt % to about 80 wt % of the asphalt or oil phase, about 0.01 wt % to about 40 wt %, about 0.1 wt % to about 10 wt % of the asphalt or oil phase, or about 0.01 wt % or less, or less than, equal to, or greater than about 0.1 wt %, 1, 2, 3, 4, 5, 6, 7, 8, 9, 10, 12, 14, 16, 18, 20, 25, 30, 35, 40, 45, 50, 55, 60, 65, 70, 75, or about 80 wt % or more of the asphalt or oil phase. The one or more additives can each independently be added at any time during formation of the emulsion, such as prior to or during formation of the emulsion, or after formation of the emulsion.

The emulsion can be used for any suitable purpose. The emulsion can be for pavement preservation or maintenance, pavement construction, asphalt recycling, asphalt reclamation, asphalt stabilization, industrial coating, paint, or a combination thereof.

The emulsion can be an asphalt emulsion, and the emulsion can be for pavement preservation, chip seal, rejuvenating scrub seal, fog seal, soil reclamation, full-depth reclamation, base stabilization, dust suppression, soil or base layer stabilizer, asphalt coatings, asphalt rejuvenation, rejuvenating fog seal, cold recycling, cold mix applications, cold patch applications (e.g., high performance cold patch applications), treatment of reclaimed asphalt or recycled bituminous materials for use in paving applications, or a combination thereof.

The emulsion can be an oil emulsion, and the emulsion can be used for pavement rejuvenation, rejuvenating fog seal, cold mix applications, cold patch applications (e.g., high performance cold patch applications), or a combination thereof.

### Other Compositions Including the Emulsifier.

Various embodiments provide a composition including the emulsifier or including the emulsifier composition. The composition can be a curable composition, a hydrophobization composition, an antistripping additive, a warm mix composition, a compaction aid, or a combination thereof.

### Method of Making the Emulsion.

Various embodiments provide a method of making an emulsion that includes the emulsifier or the emulsifier composition. The method can include combining the asphalt or oil, the water, and the emulsifier or emulsifier composition, to form the emulsion. The method can further include combining any one or more emulsion additives, to form the emulsion, such as antifoaming agents, defoamers, or surface tension modifiers.

In some embodiments the composition can be self-emulsifiable without application of significant shear, such as with high loadings of the emulsifier. Forming the emulsion can include applying shear to the mixture of the asphalt or oil, the water, and the emulsifier or emulsifier composition. Applying shear can include using a high shear mill, a colloidal mill, or a combination thereof.

### Method of Using the Emulsion.

Various embodiments provide a method of using the emulsion. The method can include contacting the emulsion and asphalt or bituminous material (e.g., a blend including asphalt and aggregate). The emulsion can be for pavement preservation or maintenance, pavement construction, asphalt recycling, asphalt reclamation, asphalt stabilization, industrial coating, paint, or a combination thereof.

The emulsion can be an asphalt emulsion, and the method can include using the emulsion to perform pavement preservation or maintenance (e.g., seals, crack sealants), pavement construction (e.g., tack coats, prime coats), asphalt recycling, asphalt reclamation, asphalt stabilization, chip seal, rejuvenating scrub seal, fog seal, coating asphalt, rejuvenating asphalt, cold recycling asphalt, cold mixing asphalt, cold patching asphalt, treatment of reclaimed asphalt or recycled bituminous materials for use in paving applications, or a combination thereof.

The emulsion can be an oil emulsion, and the method can include using the emulsion to perform pavement rejuvenation, rejuvenating fog seal, cold mix applications, cold patch applications, or a combination thereof.

In various embodiments, the present invention provides a method of using the emulsion to perform a chip seal. The method includes contacting the emulsion, a chip seal aggregate, and a pavement surface comprising asphalt or bituminous material, to perform a chip seal. The emulsion can be applied to the pavement surface, and the aggregate can be applied thereover. The emulsion can then be allowed to set. Aggregate that is not set into the emulsion can be optionally swept away.

### EXAMPLES

Various embodiments of the present invention can be better understood by reference to the following Examples which are offered by way of illustration. The present invention is not limited to the Examples given herein.

As used herein, acid value refers to the mass of potassium hydroxide needed in mg to neutralize one gram of sample according to AOCS Cd 3d-63. Acid value is a way of quantifying the amount of free fatty acid in a sample and has the units mg KOH/g.

As used herein, total amine value refers to the mass of potassium hydroxide in mg equivalent to basicity in one gram of sample according to AOCS Tf 1a-64 Amine value is a way of quantifying the amount of free amines in a sample that has the units mg KOH/g.

As used herein, tertiary amine value refers to the mass of potassium hydroxide in mg equivalent to the tertiary amine basicity in one gram of sample. Tertiary amine value is a way of quantifying the amount of tertiary amines in an amine containing sample that has the units mg KOH/g

### Example 1: Amide of Distillate and N,N-dimethyl-1,3-diaminopropane (dimethylaminopropylamine, DMAPA)

Fatty acids derived from vegetable oil processing streams such as distillates can be used as a desirable and unique source of fatty acids. In the present example 473.13 g. (1 mol) of a distillate from soybean processing and a small amount of coconut fatty acid (6.29 g) were melted and charged to a 1 L round-bottom flask along with excess amount of DMAPA (176.86 g, 1.14-1.23 mol). The mixture was heated to 120° C. for 30 minutes to allow the salt intermediates to melt. Reaction is then continued at 160-170° C. to undergo amidation under a nitrogen gas sparge (150-300 L/hr) and a condenser setup to condense any carried-over fatty distillate and water from the reaction. Significant amounts of amines were lost during the reaction process due to co-distillation of free amines and water. The reaction was monitored by assessing the amine value, tertiary amine value, and acid value (AV). The reaction was deemed complete once the AV levels were within 0-10 mg KOH/g, indicating a desired level of fatty acid containing material consumption. The final product had an amine value of 141.39 mg KOH/g, a tertiary amine value of 143.18 mg KOH/g, and an acid value of 9.58 mg KOH/g.

To accommodate potential early amine loss and subsequent stalling of the reaction progression due to depletion of amines or limited availability of amines, additional DMAPA was added towards the end of the reaction.

### Example 2. Amide of Acidulated and Distilled Sunflower Soap Stock and DMAPA

A waste-derived fatty acid was heated to about 40° C. to melt, and charged (354.1 g) to a 1 L round bottom flask along with DMAPA (118 g). The mixture is heated to 120° C. for 30 minutes to allow the salts intermediates to melt. The reaction was continued at 160-170° C. to undergo amidation with nitrogen sparge (150-300 L/hr) and a condenser setup to condense any carried-over fatty distillate and water from the reaction. The reaction was deemed complete once the AV levels within 0-10 mg KOH/g, indicating a desired level of consumption of the fatty acid containing material. The final product had an amine value of 139.07 mg KOH/g and an acid value of 10.32 mg KOH/g.

### Example 3. Amide of Refined Bleached and Deodorized (RBD) Soybean Oil and DMAPA

RBD Soybean oil (486.33 g, 1 mol) was added to a high pressure Parr reactor along with DMAPA (162.69 g, 2.85 mol) and 85% potassium hydroxide (0.975 g) as a catalyst in an inert closed system vessel. The reaction is heated to 130° C. in a closed system. Pressure build-up was allowed up to 5-9.5 psi to reduce the cycle time. Both amine value and FTIR ester-to-amide peak ratios (E/A) were closely monitored throughout the reaction. The reaction was deemed complete once E/A value tapered off at around 0.0-0.2, which indicated the disappearance of ester as opposed to the amide peak, and the tertiary amine to total amine value ratio stalled at 85-95%. The final product had an amine value of 147.37 mg KOH/g, tertiary amine value of 136.77 mg KOH/g, and E/A of 0.1.

### Example 4. Amide of Recovered Corn Oil (Corn Stover Oil) and DMAPA

Recovered corn oil (371 g, 1 mol) was added to a 1 L round bottom flask along with DMAPA (128.5 g, 2.98 mol) and 50% hypophosphorous acid (HPPA) (1.00 g). The reaction material was heated to 130-160° C. Both amine value and E/A were closely monitored throughout the reaction. The reaction was deemed complete once E/A value tapered off at around 0.0-0.2, which indicated the disappearance of ester as opposed to the amide peak. The final product had an amine value of 131.87 mg KOH/g, and an E/A of 0.05.

### Example 5. Amide of Coconut Oil and DMAPA

Coconut oil (438 g, 1 mol) and 234.7 g of DMAPA (2.99 mol) were added to a 1 L round bottom flask. The reaction material was heated to 130-160° C. Both amine value and E/A were closely monitored throughout the reaction. The reaction was deemed complete once E/A value tapered off at around 0.0-0.2, which indicated the disappearance of ester as opposed to the amide peak. The final product had an amine value of 172 mg KOH/g, tertiary amine value of 171 mg KOH/g and an E/A of 0.08.

### Example 6. Cationic Asphalt Emulsions of the Emulsifier of Example 4

In the following examples cationic asphalt emulsions were prepared using the following procedure: The asphalt binder was placed and measured out and stored in a 135° C. oven for 1-2 hrs, during which the soap solutions were prepared through addition of the emulsifier to city water (both preheated at about 50-60° C.) to a glass beaker under continued agitation and pH monitoring. A 37% HCl solution is slowly added to the solution until a pH of about 2.0 is achieved. The soap solution is then stored in a 70° C. oven, typically for about 30-60 minutes. The soap and asphalt binder are milled together in a recirculating Benedict emulsion mill for 60 seconds.

In the present example cationic emulsions were prepared with various embodiments of this invention, using different base asphalt grades, residue contents, and emulsifier dosages (B.W.E.=by weight of emulsion). Results are shown in Table 1.

TABLE 1
Cationic emulsions prepared using different base asphalt grades, residue contents, and emulsifier dosages.

| | Emulsion Sample Name | | | | | | | | | | |
|---|---|---|---|---|---|---|---|---|---|---|---|
| Component | E6-1 | E6-2 | E6-3 | E6-4 | E6-5 | E6-6 | E6-7 | E6-8 | E6-9 | E6-10 | E6-1 [symbol] |
| Asphalt Residue | 66% | 64% | 66% | 68% | 68% | 65% | 66% | 66% | 66% | 66% | 64% |
| Asphalt grade | PG58-28 | PG67-22 | PG58-28 | PG58-28 | PG58-28 | PG64-22 | PG64-22 | PG64-22 | PG64-22 | PG64-22 | PG58-28 |
| Emulsifier #1, | — | — | — | — | — | — | — | — | — | 0.30 | |
| % BWE | | | | | | | | | | | |
| Emulsifier #3, | 0.25 | 0.25 | 0.30 | 0.35 | 0.30 | — | — | — | — | — | — |
| % BWE | | | | | | | | | | | |
| Emulsifier #4, | — | — | — | — | — | 0.15 | 0.25 | 0.30 | 0.45 | — | — |
| % BWE | | | | | | | | | | | |
| Emulsifier #5, | — | — | — | — | — | — | — | — | — | — | 1.40 |
| % BWE | | | | | | | | | | | |
| 37% HCl, | 0.12 | 0.12 | 0.14 | 0.15 | 0.18 | 0.15 | 0.18 | 0.21 | 0.19 | 0.16 | 0.55 |
| % BWE | | | | | | | | | | | |
| City Water, | 33.64 | 33.64 | 33.51 | 31.43 | 31.51 | 34.39 | 34.62 | 33.33 | 33.82 | 33.65 | 34.36 |
| % BWE | | | | | | | | | | | |
| Soap pH | 2.0-2.5 | 2.0-2.5 | 2.0-2.5 | 2.0-2.5 | 2.0-2.5 | 2.0-2.5 | 2.0-2.5 | 2.0-2.5 | 2.0-2.5 | 2.0-2.5 | 2.0-2.5 |

[symbol]

indicates data missing or illegible when filed

### Example 7. Plant-Produced Emulsion

A cationic rapid setting emulsion was prepared using a PG58-28 binder at a plant scale using a large-scale colloidal mill. The resulting emulsion, described in Table 2, was tested for typical emulsion quality control protocols for use in a chip seal application. The emulsion had a specification viscosity window of 200 to 400 seconds, as measured using the Saybolt viscometer at 50° C. following ASTM D7496. The emulsion was also held in storage for additional 6 days to check viscosity stability and emulsion quality. Table 3 illustrates quality control and viscosity results.

TABLE 2
Asphalt emulsion components.

| | Emulsion |
|---|---|
| Component | E7-1 |
| PG58-28 Asphalt Binder, % BWE | 66% |
| Emulsifier #3, % BWE | 0.32% |
| 37% HCl, % BWE | 0.13% |
| City Water, % BWE | 33.51% |
| Soap pH | 1.8-2.2 |

TABLE 3
Quality control and viscosity results.

| Days after production | 0 | 1 | 2 | 3 | 5 |
|---|---|---|---|---|---|
| Saybolt Viscosity (sec)- | 204 | 282 | 357 | 368 | 402 |
| ASTM D7496 | | | | | |
| Sieve Retains on #20 | 0.01 | — | — | — | 0.01 |
| Mesh (%)-ASTM D6933 | | | | | |

The quality control testing of the residue showed a 65.8% residue by distillation, residue penetration of 117 dmm, and a ductility of >70 cm. The results overall indicated a positive viscosity building trend, with a multi-day stability both in terms of storage (low sieve values) and viscosity. Furthermore, desirable viscosities were achieved using relatively low residue of asphalt, contributing to an economical emulsion. In the field, good break and set time were observed within 20 to 40 minutes in both sun and shade.

### Example 8. Performance Testing of CRS Emulsions with Emulsifiers #1 and #3

Emulsions were prepared in accordance to the procedure described in Example 6 and tested in accordance to the ASTM D7000 Sweep Test. This test showed the ability of the chip seal to retain aggregates after a specific amount of set time. The results, as illustrated in Table 4, demonstrated an impressive ability to retain aggregates.

TABLE 4
Sweep test results.

| | Dosage (B.W.E.) | |
|---|---|---|
| Component | E8-1 | E8-2 |
| Pen 150 dmm Binder Residue, % BWE | 67% | 67% |
| Emulsifier #1, % BWE | 0.30% | — |
| Emulsifier #3, % BWE | — | 0.3% |
| Soap pH | 2.0 | 2.0 |
| ASTM D7000 Chip Loss (% wt. of total chip) | 8.2% | 8.7% |

### Example 9. Viscosity Stability for Emulsifier #3

Emulsions were prepared in accordance to the procedure described in Example 6 and tested in accordance ASTM D7496 for Saybolt viscosity over time to demonstrate viscosity stability behavior. Table 5 shows the asphalt emulsions prepared. Table 6 illustrates the viscosity measurements, which demonstrated very good viscosity stability over lengthy storage time.

TABLE 5
Asphalt emulsions prepared.

| | Emulsion Sample Name | | | | |
|---|---|---|---|---|---|
| Component | E9-1 | E9-2 | E9-3 | E9-4 | E9-5 |
| Asphalt Residue | 66% | 68% | 68% | 66% | 66% |
| Asphalt grade/Type | PG58- | Polymer | Polymer | PG58- | PG58- |
| | 28 | Modified | Modified | 28 | 28 |
| Latex (Chloroprene | — | — | — | 2.77 | 2.77 |
| 115), % | | | | | |
| Emulsifier #3, % | 0.25 | 0.35 | 0.30 | 0.35 | 0.30 |
| Soap pH | 1.8-2.2 | 1.8-2.2 | 1.8-2.2 | 1.8-2.2 | 1.8-2.2 |

TABLE 6
Asphalt emulsion viscosity stability.

| Saybolt | | | | | | |
|---|---|---|---|---|---|---|
| Viscosity (sec) | Day 0 | Day 2 | Day 7 | Day 10 | Day 14 | Day 30 |
| E9-1 | 25 | 32 | 28 | 30 | 36 | — |
| E9-2 | 74 | 67 | 76 | 80 | 65 | — |
| E9-3 | 119 | 132 | 139 | 165 | 112 | — |
| E9-4 | 50 | 43 | — | — | — | 63 |
| E9-5 | 47 | 43 | — | 48 | 55 | 67 |

### Example 10. Emulsified Rejuvenator Application

A series of biorenewable based rejuvenators from Cargill, Anova 1900, Anova 1815, Anova 1816, and Anova 1845, were emulsified with the emulsifier of Example 3 for the purpose of creating a rejuvenating fog seal pavement application. Scleroglucen was used as an emulsion stabilizer/thickener. The formulations shown in Table 7 were prepared.

TABLE 7
Rejuvenator emulsions for fog seal pavement application.

| | Emulsion Sample Name | | | | | | |
|---|---|---|---|---|---|---|---|
| Component | E10-1 | E10-2 | E10-3 | E10-4 | E10-5 | E10-6 | E10-7 |
| Anova 1900 Residue, | 66% | 60% | 60% | 60% | 60% | 70% | 70% |
| % BWE | | | | | | | |
| Emulsifier #1, % BWE | 0.62 | 0.70 | 0.70 | 1.00 | 1.00 | 0.70 | 1.00 |
| 37% HCl, % BWE | 0.21 | 0.33 | 0.33 | 0.47 | 0.47 | 0.33 | 0.47 |
| Plymouth City Water, | 34.10 | 38.89 | 38.89 | 38.48 | 38.44 | 28.91 | 28.48 |
| % BWE | | | | | | | |
| Soap pH | 2.0-4.0 | 2.0-4.0 | 2.0-4.0 | 2.0-4.0 | 2.0-4.0 | 2.0-4.0 | 2.0-4.0 |

Stable emulsions were produced, resulting in a marked reduction in liquid viscosity from 153-155 cP at 25 C for the neat Anova 1900, to emulsion viscosity of 70.4 cP. Emulsification and reduction of viscosity cutback improved the ability to uniformly spray the product through truck mounted spray-bars, improving pavement efficient coating, and final results and appearance.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Embodiments

The following exemplary embodiments are provided, the numbering of which is not to be construed as designating levels of importance:

Embodiment 1 provides an emulsifier having the structure:

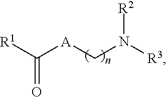

or a salt thereof wherein the —N(R²)(R³) nitrogen is quaternized as —N⁺(R²)(R³)(R⁴), or an N-oxide thereof wherein the —N(R²)(R³) nitrogen is oxidized as —N⁺(R²)(R³)(O⁻);

wherein
A is —NH— or —O—,
R¹ is chosen from (C₄-C₂₂)alkyl, substituted (C₄-C₂₂)alkyl, (C₄-C₂₂)alkenyl, and substituted (C₄-C₂₂)alkenyl,
R² and R³ are each independently chosen from (C₁-C₁₀)alkyl and substituted (C₁-C₁₀)alkyl,
R⁴ is chosen from —H, (C₁-C₂₀)hydrocarbyl, and substituted (C₁-C₂₀)hydrocarbyl, and
n is 1 to 10.

Embodiment 2 provides the emulsifier of Embodiment 1, wherein A is —NH—.

Embodiment 3 provides the emulsifier of Embodiment 1, wherein A is —O—.

Embodiment 4 provides the emulsifier of any one of Embodiments 1-3, wherein the emulsifier is the salt.

Embodiment 5 provides the emulsifier of any one of Embodiments 1-4, wherein the salt has the structure:

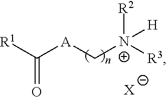

wherein X⁻ is a halide ion, an organic conjugate base, or a mineral acid conjugate base.

Embodiment 6 provides the emulsifier of any one of Embodiments 1-5, wherein the salt is a hydrochloride salt.

Embodiment 7 provides the emulsifier of any one of Embodiments 1-6, wherein the —N(R²)(R³) nitrogen is quaternized as —N⁺(R²)(R³)(R⁴) and the emulsifier comprises a counterion.

Embodiment 8 provides the emulsifier of any one of Embodiments 1-7, wherein the emulsifier is not a salt.

Embodiment 9 provides the emulsifier of any one of Embodiments 1-8, wherein R¹ is derived from a petrochemical fatty acid source.

Embodiment 10 provides the emulsifier of any one of Embodiments 1-9, wherein R¹ is derived from a bio-based fatty acid source.

Embodiment 11 provides the emulsifier of Embodiment 10, wherein the bio-based fatty acid source is free fatty acids, a plant-based oil, animal-based oil, deodorizer distillate, recovered corn oil or derivatives thereof, refined bleached deodorized soy bean oil (RBD SBO), ultrafiltered oil, a technical grade oil, a waste vegetable-based or plant-based oil, a distillate, or a combination thereof.

Embodiment 12 provides the emulsifier of any one of Embodiments 10-11, wherein the bio-based fatty acid source is soy oil, canola oil, sunflower oil, or a combination thereof.

Embodiment 13 provides the emulsifier of any one of Embodiments 1-12, wherein R¹ is derived from a modified or unmodified fatty acid source.

Embodiment 14 provides the emulsifier of Embodiment 13, wherein the modification comprises hydrogenation, fractionation, branching, epoxidation, vulcanization, polymerization, maleic anhydride modified, acrylic acid modified, dicyclopentadiene modified, conjugation via reaction with iodine, interesterification, processing to modify acid value, processing to modify hydroxyl number, or a combination thereof.

Embodiment 15 provides the emulsifier of any one of Embodiments 13-14, wherein the modification comprises maleic anhydride modification.

Embodiment 16 provides the emulsifier of any one of Embodiments 13-15, wherein R¹ is a substituted (C₄-C₂₂)alkyl or substituted (C₄-C₂₂)alkenyl, wherein the fatty acid source comprises a fatty acid modified to contain a heteroatom chosen from oxygen, nitrogen, sulfur, phosphorus, or a combination thereof.

Embodiment 17 provides the emulsifier of any one of Embodiments 1-16, wherein IV is (C₁₀-C₂₀)alkyl or (C₁₀-C₂₀)alkenyl.

Embodiment 18 provides the emulsifier of any one of Embodiments 1-17, wherein R¹ is (C₁₆-C₁₈)alkyl or (C₁₆-C₁₈)alkenyl.

Embodiment 19 provides the emulsifier of any one of Embodiments 1-18, wherein at each occurrence, R² and R³ are each independently (C₁-C₆)alkyl

Embodiment 20 provides the emulsifier of any one of Embodiments 1-19, wherein at each occurrence, R² and R³ are each independently (C₁-C₃)alkyl.

Embodiment 21 provides the emulsifier of any one of Embodiments 1-20, wherein R⁴ is —H or (C₁-C₂₀)hydrocarbyl.

Embodiment 22 provides the emulsifier of any one of Embodiments 1-21, wherein R⁴ is —H.

Embodiment 23 provides the emulsifier of any one of Embodiments 1-22, wherein n is 1 to 6.

Embodiment 24 provides the emulsifier of any one of Embodiments 1-23, wherein the n is 2 to 4.

Embodiment 25 provides the emulsifier of any one of Embodiments 1-24, wherein n is 3.

Embodiment 26 provides the emulsifier of any one of Embodiments 1-25, wherein the emulsifier has the structure:

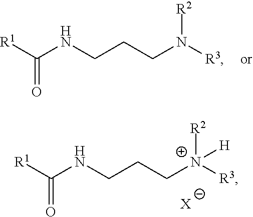

wherein
X⁻ is a halide ion, and
at each occurrence, R² and R³ are each independently (C₁-C₃)alkyl.

Embodiment 27 provides the emulsifier of any one of Embodiments 1-26, wherein X⁻ is a chloride ion.

Embodiment 28 provides the emulsifier of any one of Embodiments 1-27, wherein R² and R³ are each is methyl.

Embodiment 29 provides the emulsifier of any one of Embodiments 1-28, wherein the emulsifier has an acid value of about 0 to about 20 mg KOH/g.

Embodiment 30 provides the emulsifier of any one of Embodiments 1-29, wherein the emulsifier has an acid value of about 0 to about 10 mg KOH/g.

Embodiment 31 provides the emulsifier of any one of Embodiments 1-30, wherein in the non-quaternary non-oxide form the emulsifier has an amine value of about 100 to about 200 mg KOH/g.

Embodiment 32 provides the emulsifier of any one of Embodiments 1-31, wherein in the non-quaternary non-oxide form the emulsifier has an amine value of about 140 to about 160 mg KOH/g.

Embodiment 33 provides the emulsifier of any one of Embodiments 1-32, wherein the emulsifier is formed by amidation of a combination of coconut fatty acid and a distillate from soybean processing and coconut fatty acid with dimethylaminopropylamine.

Embodiment 34 provides the emulsifier of any one of Embodiments 1-33, wherein the emulsifier is formed by amidation of acidulated and distilled sunflower soap stock (i.e., a waste-derived fatty acid) with dimethylaminopropylamine.

Embodiment 35 provides the emulsifier of any one of Embodiments 1-34, wherein the emulsifier is formed by amidation of refined bleached and deodorized soybean oil with dimethylaminopropylamine.

Embodiment 36 provides the emulsifier of any one of Embodiments 1-35, wherein the emulsifier is formed by amidation of recovered corn oil (i.e., corn stover oil) and dimethylaminopropylamine.

Embodiment 37 provides the emulsifier of any one of Embodiments 1-36, wherein the emulsifier is formed by amidation of coconut oil and dimethylaminopropylamine.

Embodiment 38 provides an emulsifier composition comprising the emulsifier of any one of Embodiments 1-37, further comprising a monoacylglyceride or diacylglyceride compound:

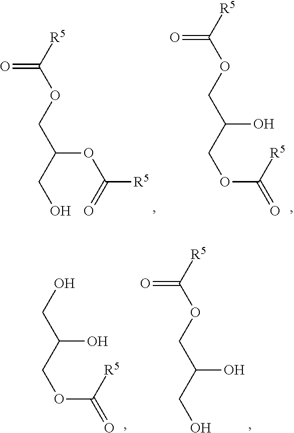

or a combination thereof,

wherein R⁵ is substituted or unsubstituted (C₄-C₂₂)alkyl or substituted or unsubstituted (C₄-C₂₂)alkenyl.

Embodiment 39 provides the emulsifier composition of Embodiment 38, wherein R⁵ is R¹.

Embodiment 40 provides the emulsifier composition of any one of Embodiments 38-39, wherein at each occurrence R⁵ is (C₁₀-C₂₀)alkyl or (C₁₀-C₂₀)alkenyl.

Embodiment 41 provides the emulsifier composition of any one of Embodiments 38-40, wherein at each occurrence R⁵ is (C₁₆-C₁₈)alkyl or (C₁₆-C₁₈)alkenyl.

Embodiment 42 provides an emulsifier comprising a modified product of the emulsifier of any one of Embodiments 1-37.

Embodiment 43 provides the modified emulsifier of Embodiment 42, wherein the modification comprises hydrogenation, fractionation, branching, epoxidation, vulcanization, polymerization, maleic anhydride modified, acrylic acid modified, dicyclopentadiene modified, conjugation via reaction with iodine, interesterification, processing to modify acid value, processing to modify hydroxyl number, or a combination thereof.

Embodiment 44 provides a modified emulsifier composition comprising a modified product of the emulsifier composition of any one of Embodiments 38-41.

Embodiment 45 provides the modified emulsifier composition of Embodiment 44, wherein the modification comprises hydrogenation, fractionation, branching, epoxidation, vulcanization, polymerization, maleic anhydride modified, acrylic acid modified, dicyclopentadiene modified, conjugation via reaction with iodine, interesterification, processing to modify acid value, processing to modify hydroxyl number, or a combination thereof.

Embodiment 46 provides a method of making the emulsifier of any one of Embodiments 1-37, or the emulsifier composition of Embodiment 38-41, the method comprising:

contacting a fatty acid source comprising R¹ and an amine starting material to form the emulsifier or emulsifier composition.

Embodiment 47 provides the method of Embodiment 46, wherein the fatty acid source and the amine starting material are contacted at about 100° C. to about 200° C.

Embodiment 48 provides the method of any one of Embodiments 46-47, wherein the fatty acid source and the amine starting material are contacted at about 130° C. to about 170° C.

Embodiment 49 provides the method of any one of Embodiments 46-48, comprising treating the emulsifier with an acid to form an acid salt of the emulsifier.

Embodiment 50 provides the method of Embodiment 49, wherein the acid is a mineral acid that is HCl.

Embodiment 51 provides the method of Embodiment 49, wherein the acid is phosphoric acid.

Embodiment 52 provides the method of any one of Embodiments 46-51, wherein the method is free of forming an acid salt of the emulsifier.

Embodiment 53 provides the method of any one of Embodiments 46-52, comprising quaternizing the —N(R²)(R³) nitrogen as —N⁺(R²)(R³)(R⁴), or wherein the amine starting material comprises the functional group —N⁺(R²)(R³)(R⁴).

Embodiment 54 provides the method of any one of Embodiments 46-53, comprising removing water from the reaction to drive the reaction toward the emulsifier.

Embodiment 55 provides the method of any one of Embodiments 46-54, wherein the fatty acid source comprises one or more fatty acids, one or more triglycerides, or a combination thereof.

Embodiment 56 provides the method of any one of Embodiments 46-55, wherein the fatty acid source is a petrochemical fatty acid source, a bio-based fatty acid source, a modified fatty acid source, an unmodified fatty acid source, or a combination thereof.

Embodiment 57 provides the method of any one of Embodiments 46-56, wherein the amine starting material has the structure:

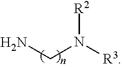

Embodiment 58 provides the method of any one of Embodiments 46-57, wherein the amine starting material has the structure:

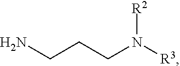

wherein R² and R³ are each independently (C₁-C₃)alkyl.

Embodiment 59 provides the method of any one of Embodiments 46-58, wherein the amine starting material is dimethylaminopropylamine (DMAPA).

Embodiment 60 provides a emulsion comprising the emulsifier of any one of Embodiments 1-37, the emulsifier composition of any one of Embodiments 38-41, the modified emulsifier of any one of Embodiments 42-43, the modified emulsifier composition of any one of Embodiments 44-45, or a combination thereof, the emulsion comprising water and a hydrophobic phase.

Embodiment 61 provides an emulsion, comprising:

asphalt, oil, or a combination thereof;

water; and

the emulsifier of any one of Embodiments 1-37, the emulsifier composition of any one of Embodiments 38-41, the modified emulsifier of any one of Embodiments 42-43, the modified emulsifier composition of any one of Embodiments 44-45, or a combination thereof.

Embodiment 62 provides the emulsion of Embodiment 61, wherein the asphalt or oil is about 10 wt % to about 90 wt % of the emulsion.

Embodiment 63 provides the emulsion of any one of Embodiments 61-62, wherein the asphalt or oil is about 30 wt % to about 80 wt % of the emulsion.

Embodiment 64 provides the emulsion of any one of Embodiments 61-63, wherein the emulsion is an asphalt emulsion.

Embodiment 65 provides the emulsion of any one of Embodiments 61-64, wherein the asphalt comprises flux, refinery vacuum tower bottoms, pitch or other residues of processing of vacuum tower bottoms, oxidized or aged asphalt from recycled bituminous material, material acquired from asphalt producing refineries, solvent de-asphalting residues, pitch, brightstock, or residues, side streams, or residues remaining from the production of brightstock, or a combination thereof.

Embodiment 66 provides the emulsion of any one of Embodiments 61-65, wherein the emulsion is an oil emulsion.

Embodiment 67 provides the emulsion of Embodiment 66, wherein the oil is a rejuvenating oil, a vegetable oil, a polymerized oil, or a combination thereof.

Embodiment 68 provides the emulsion of any one of Embodiments 61-67, wherein the water is about 10 wt % to about 90 wt % of the emulsion.

Embodiment 69 provides the emulsion of any one of Embodiments 61-68, wherein the water is about 20 wt % to about 70 wt % of the emulsion.

Embodiment 70 provides the emulsion of any one of Embodiments 61-69, wherein the emulsifier is about 0.01 wt % to about 3 wt % of the emulsion.

Embodiment 71 provides the emulsion of any one of Embodiments 61-70, wherein the emulsifier is about 0.1 wt % to about 1.5 wt % of the emulsion.

Embodiment 72 provides the emulsion of any one of Embodiments 61-71, wherein the emulsifier is about 0.15 wt % to about 0.45 wt % of the emulsion.

Embodiment 73 provides the emulsion of any one of Embodiments 61-72, wherein the emulsifier is about 0.3 wt % to about 1.5 wt % of the emulsion.

Embodiment 74 provides the emulsion of any one of Embodiments 61-73, wherein water in the emulsion has a pH of about 1.0 to about 3.0.

Embodiment 75 provides the emulsion of any one of Embodiments 61-74, wherein the water in the emulsion has a pH of about 1.8 to 2.2.

Embodiment 76 provides the emulsion of any one of Embodiments 61-75, further comprising one or more additives comprising a rejuvenator, a rejuvenating oil, a rheology modifier, a compatibilizer, a diluent, a cutback, a fuel oil, a pigment, a thermoplastic polymer, an elastomeric polymer, tire rubber, a natural or synthetic latex, polyphosphoric acid, lecithin, a gum, a fatty acid, an anti-stripping additive, a warm mix additive, a co-surfactant or co-emulsifier, a viscosity modifier, a fiber, an emulsion stabilizer, an antioxidant, a defoamer, an antifoamer, a surface tension modifier, or a combination thereof.

Embodiment 77 provides the emulsion of any one of Embodiments 61-76, wherein the one or more additives are about 0.01 wt % to about 80 wt % of the asphalt or oil.

Embodiment 78 provides the emulsion of any one of Embodiments 61-77, wherein the one or more additives are about 0.1 wt % to about 10 wt % of the asphalt or oil.

Embodiment 79 provides the emulsion of any one of Embodiments 61-78, wherein the emulsion is for pavement preservation or maintenance, pavement construction, asphalt recycling, asphalt reclamation, asphalt stabilization, industrial coating, paint, or a combination thereof.

Embodiment 80 provides the emulsion of any one of Embodiments 61-79, wherein the emulsion is an asphalt emulsion, wherein the emulsion is for pavement preservation, chip seal, rejuvenating scrub seal, fog seal, soil reclamation, full-depth reclamation, base stabilization, dust suppression, soil or base layer stabilizer, asphalt coatings, asphalt rejuvenation, rejuvenating fog seal, cold recycling, cold mix applications, cold patch applications, treatment of reclaimed asphalt or recycled bituminous materials for use in paving applications, or a combination thereof.

Embodiment 81 provides the emulsion of any one of Embodiments 61-80, wherein the emulsion is an asphalt emulsion for chip seal.

Embodiment 82 provides the emulsion of any one of Embodiments 61-81, wherein the emulsion is an oil emulsion, wherein the emulsion is for pavement rejuvenation, rejuvenating fog seal, cold mix applications, cold patch applications, or a combination thereof.

Embodiment 83 provides a curable composition, a hydrophobization composition, an antistripping additive, a warm mix composition, a compaction aid, or a combination thereof, comprising: the emulsifier of any one of Embodiments 1-37, the emulsifier composition of any one of Embodiments 38-41, the modified emulsifier of any one of Embodiments 42-43, the modified emulsifier composition of any one of Embodiments 44-45, or a combination thereof.

Embodiment 84 provides a method of making the emulsion of any one of Embodiments 61-82, the method comprising:

combining the asphalt or oil, the water, and the emulsifier, to form the emulsion.

Embodiment 85 provides the method of Embodiment 84, wherein making the emulsion comprises applying shear.

Embodiment 86 provides the method of Embodiment 85, wherein applying shear comprises using a high shear mill, a colloidal mill, or a combination thereof.

Embodiment 87 provides a method of using the emulsion of any one of Embodiments 61-82, the method comprising:

contacting the emulsion of any one of Embodiments 61-82 and asphalt or bituminous material.

Embodiment 88 provides the method of using the emulsion of Embodiment 87, wherein the emulsion is an asphalt emulsion, the method comprising using the emulsion to perform pavement preservation or maintenance, pavement construction, asphalt recycling, asphalt reclamation, asphalt stabilization, chip seal, rejuvenating scrub seal, fog seal, coating asphalt, rejuvenating asphalt, cold recycling asphalt, cold mixing asphalt, cold patching asphalt, treatment of reclaimed asphalt or recycled bituminous materials for use in paving applications, or a combination thereof.

Embodiment 89 provides a method of using the emulsion of any one of Embodiments 61-82, the method comprising:

contacting the emulsion of any one of Embodiments 61-82, a chip seal aggregate, and a pavement surface comprising asphalt or bituminous material, to perform a chip seal.

Embodiment 90 provides the method of using the emulsion of Embodiment 87, wherein the emulsion is an oil emulsion, the method comprising using the emulsion to perform pavement rejuvenation, rejuvenating fog seal, cold mix applications, cold patch applications, or a combination thereof.

Embodiment 91 provides the emulsifier, emulsifier composition, modified emulsifier, the modified emulsifier composition, emulsion, or method of any one or any combination of Embodiments 1-90 optionally configured such that all elements or options recited are available to use or select from.

1. (canceled)

2. The emulsion of claim 14, wherein the emulsifier is the salt, wherein the —N(R²)(R³) nitrogen is quaternized as —N⁺(R²)(R³)(R⁴) and the emulsifier comprises a counterion.

3. The emulsion of claim 14, wherein R¹ is derived from a bio-based fatty acid source.

4. (canceled)

5. The emulsion of claim 14, wherein R¹ is derived from a modified fatty acid source, wherein the modification carried out with maleic anhydride.

6. The emulsion of claim 14, wherein the emulsifier has the structure: 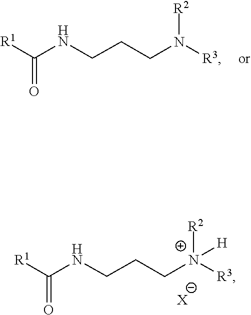
wherein
R¹ is (C₁₆-C₁₈)alkyl or (C₁₆-C₁₈)alkenyl,
X⁻ is a halide ion, an organic conjugate base, or a mineral acid conjugate base, and
at each occurrence, R² and R³ are each independently (C₁-C₃)alkyl.

7. The emulsion of claim 14, wherein the emulsifier has an acid value of about 0 to about 20 mg KOH/g.

8. The emulsion of claim 14, wherein in the non-quaternary non-oxide form the emulsifier has an amine value of about 100 to about 200 mg KOH/g.

9. The emulsion of claim 14, the emulsion further comprising a monoacylglyceride or diacylglyceride compound: 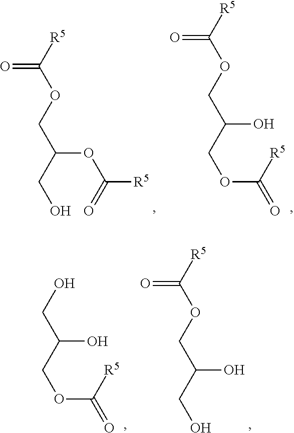
or a combination thereof,
wherein R⁵ is substituted or unsubstituted (C₄-C₂₂)alkyl or substituted or unsubstituted (C₄-C₂₂)alkenyl.

10. (canceled)

11. (canceled)

12. A method of making the of claim 14, the method comprising:
contacting a fatty acid source comprising R¹ and an amine starting material to form the emulsifier.

13. (canceled)

14. An emulsion, comprising:
asphalt, oil, or a combination thereof;
water; and
an emulsifier-having the structure: 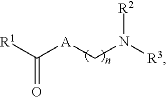
or a salt thereof wherein the —N(R²)(R³) nitrogen is quaternized as —N⁺(R²)(R³)(R⁴), or an N-oxide thereof wherein the —N(R²)(R³) nitrogen is oxidized as —N⁺(R²)(R³)(O⁻);
wherein
A is —NH— or —O—,
R¹ is chosen from (C₄-C₂₂)alkyl, substituted (C₄-C₂₂)alkyl, (C₄-C₂₂)alkenyl, and substituted (C₄-C₂₂)alkenyl,
R² and R³ are each independently chosen from (C₁-C₁₀)alkyl and substituted (C₁-C₁₀)alkyl,
R⁴ is chosen from —H, (C₁-C₂₀)hydrocarbyl, and substituted (C₁-C₂₀)hydrocarbyl, and n is 1 to 10.

15. The emulsion of claim 14, wherein the emulsion is for pavement preservation or maintenance, pavement construction, asphalt recycling, asphalt reclamation, asphalt stabilization, industrial coating, paint, or a combination thereof.

16. The emulsion of claim 14, wherein the emulsion is an asphalt emulsion, wherein the emulsion is for pavement preservation, chip seal, rejuvenating scrub seal, fog seal, soil reclamation, full-depth reclamation, base stabilization, dust suppression, soil or base layer stabilizer, asphalt coatings, asphalt rejuvenation, rejuvenating fog seal, cold recycling, cold mix applications, cold patch applications, treatment of reclaimed asphalt or recycled bituminous materials for use in paving applications, or a combination thereof.

17. (canceled)

18. A method of making the emulsion of claim 14, the method comprising:
combining the asphalt or oil, the water, and the emulsifier, to form the emulsion.

19. A method of using the emulsion of claim 14, the method comprising:
contacting the emulsion of claim 14 and asphalt or bituminous material.

20. The method of using the emulsion of claim 19, wherein the method is used to perform a chip seal.
